(19) United States
(12) Patent Application Publication
(10) Pub. No.: US 2005/0004786 A1
(43) Pub. Date: Jan. 6, 2005

(54) State machine modelling

(75) Inventor: Graham G. Thomason, Redhill (GB)

Correspondence Address: Corporate Patent Counsel, U.S. Philips Corporation, 345 Scarborough Road, Briarcliff Manor, NY, 10510, US

(73) Assignee: KONINKLIJKE PHILIPS ELECTRONICS N.V.

(21) Appl. No.: 10/712,110

(22) Filed: Nov. 13, 2003

(30) Foreign Application Priority Data
Nov. 16, 2002 (GB) 0226803.5

(51) Int. Cl. G06F 17/50

(52) U.S. Cl. 703/17

(57) ABSTRACT

A method of modelling a function call in a state machine comprises generating a model of a state machine which calls a function call. A function call mf1 is modelled in a second state machine which is independent of the first state machine. When the first state machine calls the function call, for example using a leafstate “calling”, the function call state machine mf1 is temporarily implanted over the “calling” state. Static recursion or infinite compile time recursion is avoided since the implantation is made only at the time of calling the function call, rather than at compiled time. After entering the state machine mf1, return is made to the first state machine after transition to a terminator state, which fires an event called $return (where $ indicates scoping back one level, and return indicates an event which fires the transition to state “after”). This can be described as a synchronous function call. An asynchronous function call is shown in FIG. 17. Here, a second state model is implanted in free-space, and has a lifetime which is independent of any other state machine model. An asynchronous implanted state machine returns a notification upon completion, i.e. on transition to a terminator state. Intermediate notifications may also be given. On exiting any implanted function call state machine, the implantation is deleted.

### FIELD OF THE INVENTION

This invention relates to a method of modelling a state machine comprising a first state model, and a second state model implanting a function call. The invention relates also to a computer program for instructing a computer to carry out the method, and to a computer programmed with such a computer program.

### BACKGROUND OF THE INVENTION

The increasing complexity, size and lead time of software systems is a concern to the software industry. One solution which addresses these concerns is the component-based synthesis of systems. Components provide for system modularity, customisability, maintainability and upgradeability. Large systems can be built by selecting components from repositories and binding them together, rather than by writing systems without code reuse.

This apprqach to system building presents problems in terms of the testing of the operation of the system, although the testing of the individual components is relatively straightforward. Currently available testing tools rely on a tester generating a state machine model of the system under test. The model and the system under test are then subjected to a test, and the resultant state of the model and the system compared to determine if the system performed as expected. This procedure is repeated until the system has been fully tested.

An explanation of state machines and how they are modelled now follows. It will be appreciated that the notation and the syntax used is illustrative and non-limiting. The following also describes how models are used for system testing.

Many systems can be modelled according to their state behaviour, that is their state and how the state changes as a result of some stimulus or signal, called an event. Under this modelling technique, if a system is in a given state, it will remain so indefinitely until an event occurs. The notion of a state therefore entails durability—the state exists over a period of time. Even if a system enters a particular state s1 and there is an event ready and waiting to cause a change of state (to state s2), the moment when the system is in state s1 is a point at which the system is stable in terms of its state behaviour. At such a point, the state of the system (in a wide sense) will map to a state in the model of the system.

Events are modelled as instantaneous signals which have no duration. They are able to trigger some processing in the system which may or may not result in a new state. In some states, events may be ignored by the system, leaving the system in its existing state.

A system may be of the kind that theoretically runs indefinitely, such as an operating system or real-time kernel, or it may have a clear lifecycle. However, even operating systems can generally be closed down in a controlled way.

A multi-threaded application might be modelled with states which represent the fact that low priority threads are running. Such a system would still be able to react to events which interrupt at a higher priority. It may even be necessary to represent cpu (central processing unit) bound tasks as states, perhaps using several states so as to model events as having been recorded but unable to be processed until the task completes.

Input data to a program can also often conveniently be thought of as a sequence of events. In this case, the program will normally have instant access to the next event (apart from an occasional disc-access or similar), and so will be cpu-bound, but this does not detract from the state model. An example of such a kind of program is a conversion program to convert texts from one kind of character coding to another, perhaps with situations where one character of input maps to two characters of output and vice versa. The input characters (including new lines and end-of-file) can be modelled as events. Output characters will be generated on certain state changes. Another example is a compiler where the input tokens can be regarded as events; the state is some record of completed successful parsing of ‘terms’ in production rules.

If two states show identical responses to any sequence of events that is processed from a system in such a state, then they are indistinguishable and are best modelled as one state, so as to avoid redundancy in the model.

In order to model a system, it is necessary to express all the relationships between states, events, and new states after processing the event. A transition maps a source state to a new state (the target or destination state) by means of an event. In effect, the event triggers the transition. There can be multiple target states, but this is not discussed further here. A diagram showing states and transitions is termed a state-transition diagram. States are conventionally denoted by circles, and transitions by arcs with an arrowhead. Transition arcs conventionally are annotated with the events that cause the transition. FIG. 1 shows a system having three states: a, b and c; four events: α, β, γ, and δ; and four transitions: t1, t2, t3 and t4.

At any one time, a system modelled by the FIG. 1 state-transition diagram will be in only one state. That state is called the occupied (or active) state. The others are vacant (or inactive). Transitions whose source states are vacant at the time an event occurs do not cause any state transitioning to take place—they are inapplicable in the current state. If an event occurs which is the trigger to a transition whose source state is occupied, then (apart from non-deterministic situations) the transition takes place. Here, the source state becomes vacated and the target state becomes occupied. In the FIG. 1 example, when the system is in state a, it reacts to event a by executing transition t1, i.e. by transitioning from state a to state b. If the system is not in state a, then transition t1 is not applicable because the system is not in t1's source state. Only one transition takes place as a result of one occurrence of this event, so transition t2 does not take place as well, unless and until another event α occurs. It will be appreciated that there can be several transitions emanating from any state (for example t1 and t3 from state a). Also, an event can be a trigger to more than one transition (for example α triggers t1 and t2), but, (excluding non-determinism), it is not usual to find two transitions triggered by the same event from the same source state. Furthermore, a transition can be triggered by more than one event, in which case any one of the events will trigger the transition. For example, transition t3 is triggered by event β or δ. If an event occurs which does not trigger a transition, (for example if in state b event β occurs), then the event is disregarded and no state change occurs.

The way in which the state transition diagram of FIG. 1 is represented in a possible source code language is:
statechart sc(s)
   event alpha,beta,gamma,delta;
   cluster s(a,b,c)
   state a {alpha->b;beta,delta->c;}
      state b {alpha->c;}
      state c {beta,gamma->a;}

Here, the state transition diagram is declared as a “statechart”, which consists of a cluster s, which consists of three states or leafstates a, b, and c. A cluster indicates a grouping in which no more than one member state can be occupied. Events are declared and are used in transitions, which are denoted by
events->target state;
   State behaviour modelling is part of the UML (Unified Modelling Language) dynamic view.

An implementation of a state based model of a system provides a way to automatically generate test cases for that system. According to a white-box technique, this can be set up is for a test script (TS) to communicate with the State Behaviour Model (SBM) and the Implementation Under Test (IUT), giving each instructions to put themselves in a particular state, to process an event, and to provide their new state. The test script then compares the new states as reported by each. Any mismatch is a test failure and so possibly the detection of a bug in the IUT (although it could be a modelling error, a test script error, or even a bug in the SBM). The instruction sequence is repeated for as many states and events as it is feasible to execute. A certain amount of glue-code is be needed to communicate with the IUT.

The SBM resultant state is termed the ‘oracle’ to the test, i.e. it is the expected result from the IUT. The process is illustrated in FIGS. 2A and 2B.

This technique is called white-box because it requires knowledge of the internals of the IUT in order to communicate with it in this way. Black-box techniques also exist in which the IUT is entirely event driven and its behaviour is deduced from limited observed output traces which are generated on certain transitions. In this case, transition tour algorithms provide some form of coverage of the state space.

Coverage of all states and events is obtained by looping as follows:
For all states
   For all events
      Set state in SBM and IUT
      Process event in SBM and IUT
      Get state of SBM and IUT
      Compare resultant states

This does not guarantee the correct state behaviour of the IUT—it is possible that it could show incorrect behaviour in some states under some circumstances—e.g. entering a state via one route might give rise to different subsequent state behaviour than the state behaviour when the same state is reached via a different route. Other test generation algorithms can be designed to give further coverage, for example covering all pairwise transition combinations.

Tests are preferably called in a uniform way, and each test should provide its own pass/fail criterion. The test report should produce a uniform description of whether each test passed or failed. A tool providing facilities for doing this is called a test harness.

A more detailed explanation of state machines follows. The example state machine of FIG. 1 contains three leafstates which are “wrapped” in a cluster. A cluster is a group of states (members of the cluster) such that at most one member state can be occupied. If one member is occupied, the cluster is regarded as occupied. If all members are vacant, the cluster is vacant. The members of a cluster can be other clusters, sets or leafstates. The diagrammatic notation for a cluster is a rounded rectangle with its name at the top left. One member of the cluster is designated the default member (symbol [symbol] ). If and when the cluster is initially entered or is the target state of a transition then, unless other factors come into play, the default state is entered.

Transitions can have a cluster as their source state. They can also have a cluster as a target state. This gives a compact way to express what would otherwise be multiple transitions. An example cluster is shown in FIG. 3A. The equivalent flattened state machine is shown in FIG. 3B.

A cluster can be marked with a history or deep history marker. The history data records the member that was occupied when the cluster was last occupied. On diagrams, history is marked according to the following legend:

\hat{N} = no history (default)
Ĥ = (shallow) history
\hat{D} = deep history

A cluster with a history marker, when entered without a specific member being specified, will enter the historical state. If history data is not available, the default state will be taken. Deep history indicates that historical data is to be used (assuming it is available) on re-entering the cluster and all descendant clusters below the marked cluster. The descendant clusters are entered under a deep history obligation—whether or not they have a history marker. The deep history obligation is not applicable simply because a particular cluster is below another one with a deep history marker. It must be the case that the cluster with the deep history marker is actually entered in the course of the transition for the deep history obligation to apply. History data can be cleared by a function call.

A set is another means by which states can be grouped hierarchically, which now provides a means to represent parallelism. If a set is occupied, all its members must be occupied. If the set is vacant, all its members must be vacant. The members of a set can be clusters, sets or leafstates. A set normally has at least two members, which provides a statechart with concurrency (i.e. parallelism): several states can be occupied in parallel. The notation for a set is a rounded rectangle with a tab. Members of a set are separated by a dotted line. A separate enclosing rectangle around the cluster is not required; the symbol in the member area but not in any other symbol indicates a cluster. FIG. 4 shows how members of sets can be designated. From top to bottom, these are: the member is a cluster (containing two leafstates) with the cluster name (“a”) in the member area; the member is a cluster (containing two leafstates) with no symbol outside the cluster; the member is a leafstate—note no symbol outside the leafstate—this can be useful for self-transition actions; the member is a set (in this case containing two clusters, each of which contains two leafstates); and the member is a cluster) in this case containing a cluster itself containing two leafstates).

A set cannot be marked with a history marker, since there is no choice as to which member to enter—if a set is entered, all of its members are entered. A set can be marked with a deep history marker. This means that on entry into the set and then into the set members, a deep history obligation will be passed on to all members of the set. Any clusters below the set in the hierarchy will then be entered in their historical state.

Other features in state machines are listed below:

Conditions on transitions. For example, ‘α[V1>=V2]’ on a transition means that the transition will only be made on event α if V1 is greater than or equal to V2. The conditions may be C-like boolean expressions, and may contain tests for the occupancy/vacancy of other states.

Actions on transitions, including firing additional events, executing embedded imperative code (such as C code). For example, ‘α/fire_f1’ on a transition means that event α will trigger the transition, and the transition will fire event f1.

Lambdaevents, i.e. events that are generated automatically (typically by forward chaining) when some condition becomes true such as when some variables take on some particular values.

Metaevents, i.e. events which take place when some micro-step in transition processing takes place, such as entering or exiting some particular state.

Use of scoping operators. It may be desirable to allow e.g. state, event, and variable (and, for a typed language, tag-) and other names to be identical, but to be scoped to different parts of the state hierarchy. A rough similarity comparison can be made with global and class member variables in C++, where the :: operator accesses the global variable, but in a statechart precision is required down at any hierarchical level. Scoping operators give access to the desired target name. Possible scoping operators are
descend (diadic, right-associative, infix, higher precedence), e.g. a.b.c means descend through state a down through state b to state c.
$ back (monadic, right-associative, prefix, lower precedence). Back out one level and address a state from that level. $$a means back out two levels and enter state a.
:: fromtop (monadic, right-associative, prefix, lower precedence). Back out to the outermost hierarchical level and address a state from that level.::a.b means enter state a, then from there state b, from the outermost hierarchical level.
%% ancestor (diadic, right-associative, infix, higher precedence). Back out to a named level (the left-hand operand), then enter the state(s) denoted by the right hand operand.

The above operators typically have precedences higher than those of arithmetic operators. Additional operators will be known by those skilled in the art, including operators taking an implicit this-state argument.

Currently available tools for producing state machine models are unable to model function calls accurately. A software component is accessible only through its interfaces, each interface being a collection of function calls. An operating system is an example of a software component. A function call can be considered to be made from a client to a server, a server being one who provides a service. Function calls can be synchronous or asynchronous. Binding between components A and B, one of which is a client and the other a server is shown in FIG. 5. Here, each of the components A and B ‘requires’ an interface pointer. The configurator supplies this.

Supposing a model of the state behaviour of component A and of component B exists, a problem subsists in how to obtain a model of the state behaviour of the combination of the two. This model would involve name identification (in the sense of making the names the same) between caller and callee, which can be done in the prior art. A conventional way to model function calls in a finite state machine is for each function to be a parallel machine, so that each function is available once. An example of this is shown in FIG. 6. In FIG. 6, the processing of the maximum function is artificially regarded as going through various intermediate states, and as making various additional calls (to f1 and f2). In this example, the server calculates the largest (maximum) value of the variables P1, P2 and P3, and returns the determined value to the client, by firing event ret_maximum.

The example of FIG. 6 can be visualised as applying to a situation in which the maximum function takes the maximum of a fixed reserve price and two bids, to be obtained from two different websites. Event β means that the bid has been obtained from a first website, and XX becomes an intermediate maximum. Event y means that the bid has been obtained from the second website, which allow the overall maximum to be obtained. Functions f1 and f2 are synchronous bound calls. These functions are different since they utilise different currencies and thus one function needs to apply a conversion.

Supposing f1 were implemented on the client side above, f1 clearly would be best modelled by a parallel machine (i.e. set member) on the client side. Furthermore, if f1 were to call a function g1 that was implemented back on the server side, then f2 as well would be best modelled by a parallel machine on the server side. It appears to be a general rule that all functions should be modelled as parallel machines within their component wrapper state.

FIG. 7 shows the general structure of a main component state and functions modelled as co-members of the set. In practice, the functions f1, f2, f3, f4 of FIG. 7 typically would have different signatures and state behaviour.

Functions which return a pending status and notify later may need to be modelled in a way that accepts any order of notifications. In the example of FIG. 8, the client makes two calls on a thread which cannot be interrupted on the client side. As soon as more than two functions can be outstanding, it becomes impracticable to extend this concept. Combinatorial explosion takes place of the number of states representing some, but not all notifications. A more general scheme is shown in FIG. 9.

There are limitations to the above described function call modelling schemes, in that they cannot handle re-entrant and recursive calls. Re-entrancy occurs when a first call to a function is incomplete and a second client makes a call to that function, typically on its own thread. Recursion occurs when a function directly or indirectly calls itself. It is an aim of the invention to address these shortcomings.

### SUMMARY OF THE INVENTION

According to the present invention, there is provided a method of modelling a state machine comprising a first state model, and a second state model implementing a function call, the method comprising, in response to an event in the first state model instructing the firing of the function call, implanting the second state model in the first state model.

According to a second aspect of the invention, there is provided apparatus for modelling a state machine comprising a first state model and a second state model implementing a function call, the apparatus comprising means responsive to an event in the first state model instructing the firing of the function call, for implanting the second state model in the first state model.

Using the invention, it is possible to model accurately function calls without being susceptible to combinatorial explosion of the number of states, whilst being able to deal with re-entrant and recursive calls.

In the embodiments, a function call is modelled in a second state machine which is independent of the first state machine. When the first state machine calls the function call, for example using a leafstate “calling”, the second state machine is temporarily implanted over the “calling” state. Static recursion or infinite compile time recursion is avoided since the implantation is made only at the time of calling the function call, rather than at compile time. After entering the state machine, return is made to the first state machine after transition to a terminator state, which fires an event called $return (where $ indicates scoping back one level, and ‘return’ indicates an event which fires the transition to state “after”). This can be described as a synchronous function call. In an asynchronous function call embodiment, a second state model is implanted in free-space, and has a lifetime which is independent of any other state machine model. An asynchronous implanted state machine returns a notification upon completion, i.e. on transition to a terminator state. Intermediate notifications may also be given. On exiting any implanted function call state machine, the second state machine is deleted.

### BRIEF MENTION OF THE DRAWINGS

Embodiments of the present invention will now be described, by way of example only, with reference to the accompanying drawings, of which:

FIG. 1 is an example state diagram;

FIGS. 2A and 2B show how a test script tests on implementation under test (FIG. 2B is a message sequence diagram);

FIGS. 3A and 3B illustrate the effect of a cluster;

FIG. 4 illustrates set and set member notation;

FIG. 5 illustrates how components can be bound;

FIGS. 6, 7, 8 and 9 illustrate how function calls can be modelled in the prior art;

FIGS. 10 and 11 show function call modelling according to the invention;

FIGS. 12 and 13 show configurator modelling according to the invention;

FIG. 14 shows a bound function call modelled according to the invention;

FIGS. 15 and 16 show unbound function calls modelled according to the invention;

FIGS. 17 and 18 illustrate the use of synchronous function call modelling according to the invention;

FIG. 19 shows how a chain of transitions may be created using synchronous function calls according to the invention;

FIG. 20 illustrates the use of asynchronous function calls modelled according to the invention;

FIG. 21 illustrates how the model according to the invention may deal with both synchronous and asynchronous function calls; and

FIG. 22 shows a computer using which the invention may be implemented.

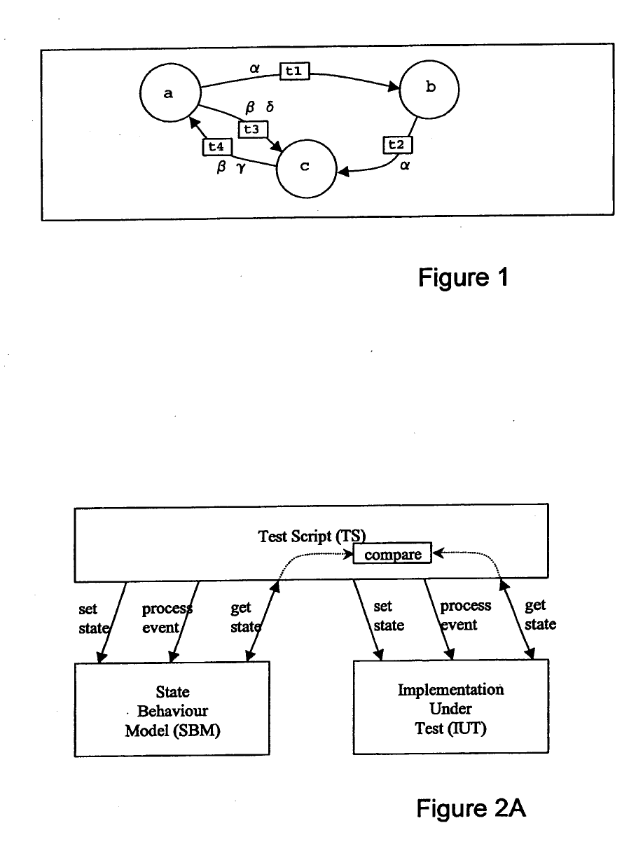

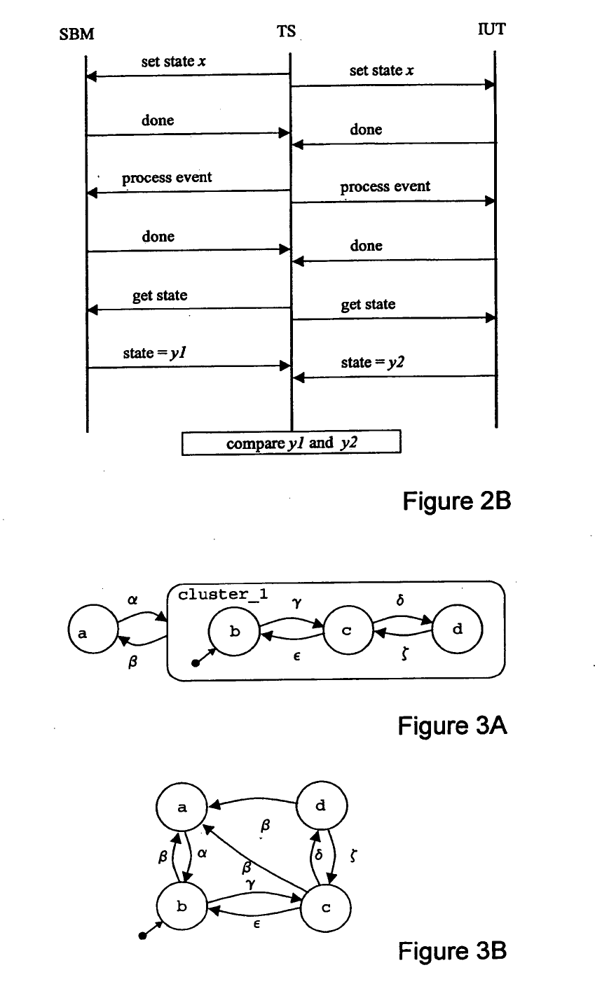

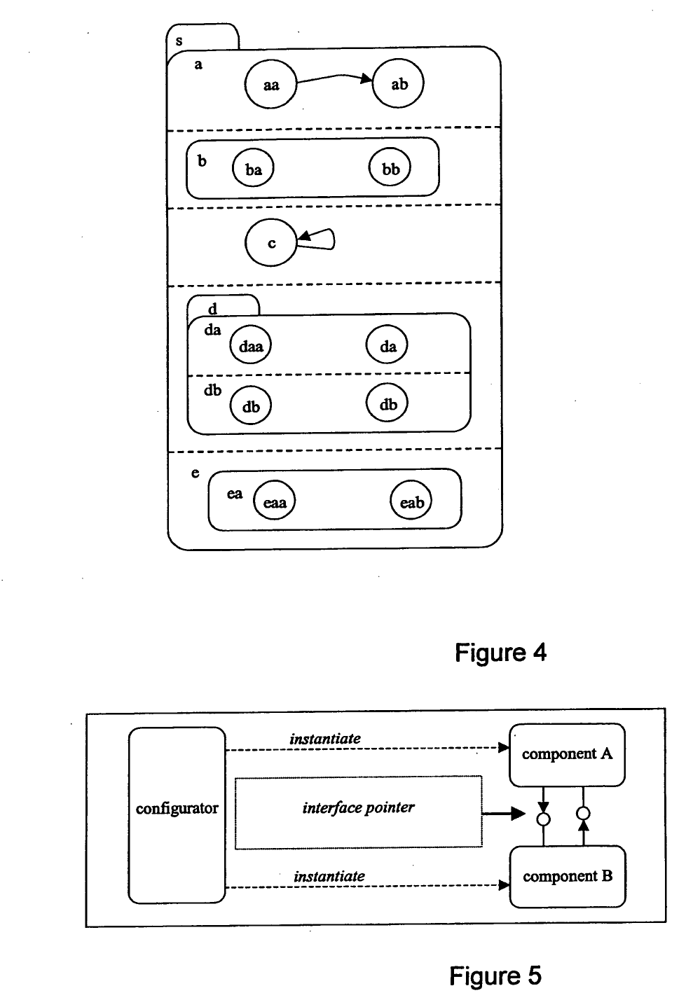

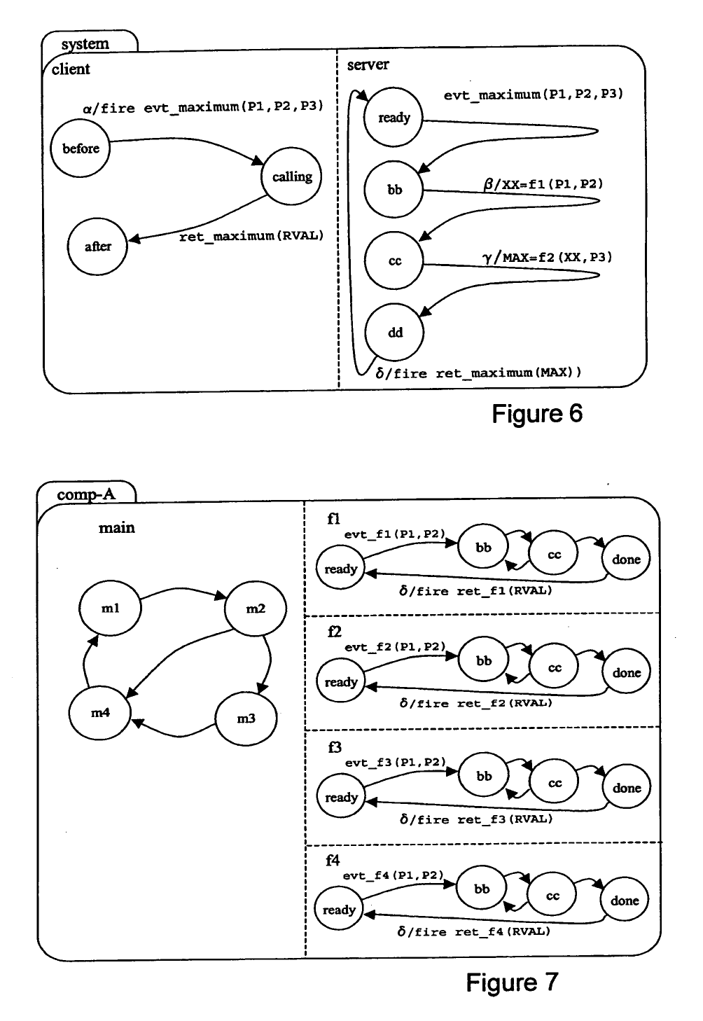

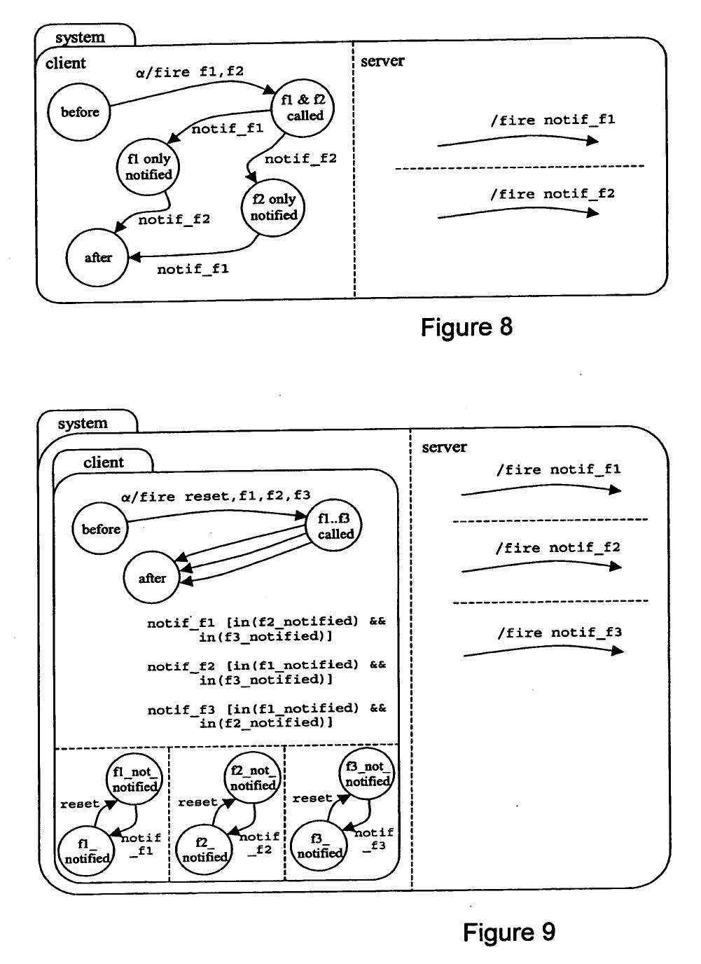

### DETAILED DESCRIPTION OF THE PREFERRED EMBODIMENTS

The invention is concerned with the modelling of state machines. The model is formed from program code prepared in any suitable programming language and running on any suitable machine. For example, the model may be programmed in Prolog™ and be run on a general purpose computer. The invention resides in the modelling, and it will be apparent to the person skilled in programming how to generate suitable program code to implement the invention.

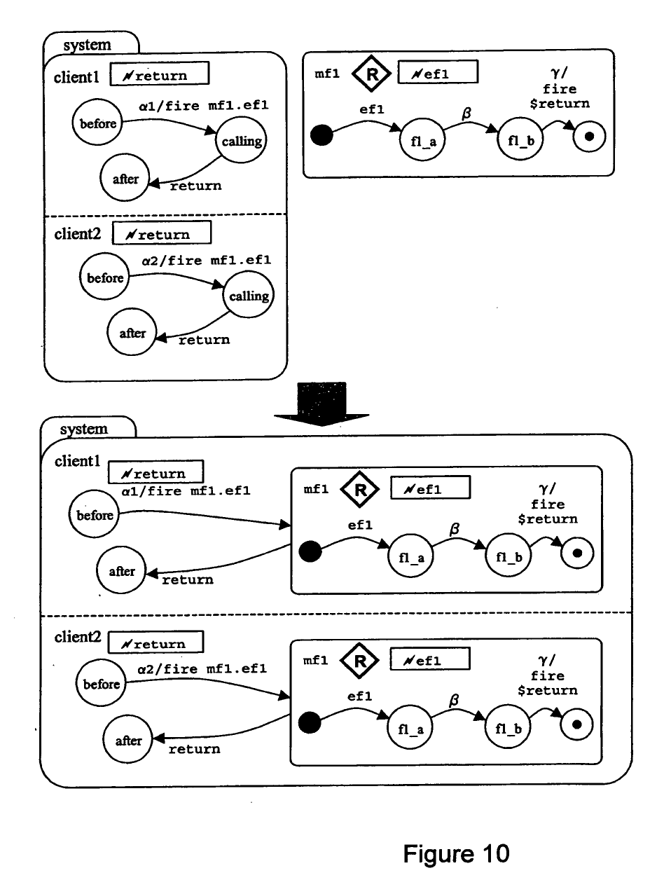

FIG. 10 shows a state machine model according to the invention. A function (f1) is modelled as a cluster named mf1. It is marked as recursive, indicating that it has been implanted from a template state chart. A ‘calling’ event (mf1.ef1) is recognized as being special, because something special happens when its transition takes place.

The special effect is as follows:
The target state (‘calling’) is temporarily overwritten (until a ‘return’ event) by an instantiation of the cluster mfl in situ. This could be termed ‘implanting’ a new part of the state machine on top of another state. Put another way, on a function call, the top part of FIG. 10 is temporarily dynamically modified into that shown in the bottom part of the Figure.
the transition triggered is processed in the instantiated member mfl. When the event can trigger several transitions within the instantiated member (perhaps with different event parameter signatures, or different conditions on the transition), each transition is dealt with as if the new member were a permanent fixture of the state machine.
When the instantiated member fires a ‘$return’ event (which is notation for a return event in the parent class's scope), the instantiated member mf1 is removed, leaving the original ‘calling’ state standing. This models the function return.

It will be noted that: The client declares a local event called ‘return’, to be used for all function returns. The symbol [symbol] represents an event declaration which the function member mf1 scopes precisely by firing ‘$return’ (the $ indicating parent scope). Thus, even with many function calls active, possibly from several clients and at various levels of nesting, there could never be any ambiguity concerning which ‘return’ is being referred to.

Also, the function-call event is modelled here as local to the member being instantiated, although it could instead be modelled in another way. The client directs the event to the member using a ‘descend’ operator (the dot), giving mf1.ef1.

Furthermore, once the function member mf1 has been instantiated, it is just like a normal fixture of a state machine model.

The special nature of function invocation could be recognized by the fact that the fired event (mf1.ef1) scopes to an event in a recursive member (mf1) or by the fact that the fired event is an action on a (client) transition which targets a state named ‘calling’. Such a state could be considered a marker state. In practice, the ‘calling’ state would have a unique name within its hierarchical position, whilst still being recognisable as a special state. This might be achieved by using ‘calling’ as a suffix or a prefix.

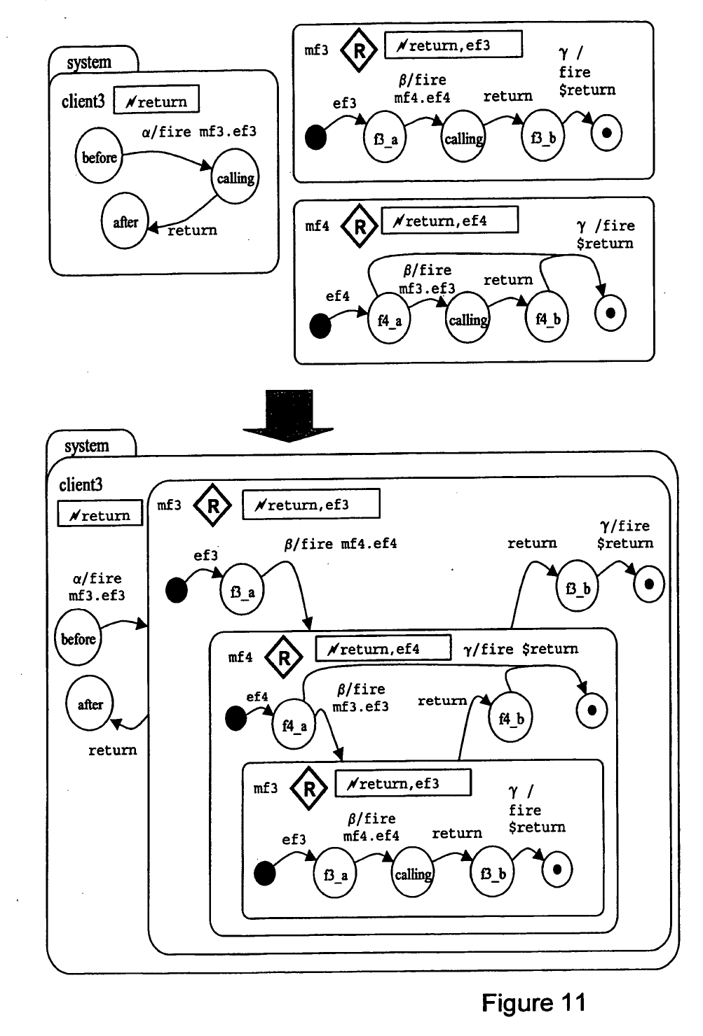

A more complex example is shown in FIG. 11. In this figure, client3 calls a function f3, which calls a function f4, which calls the function f3, at which point a snapshot is taken. The model shown at the top part of FIG. 11 is temporarily dynamically modified into that shown in the bottom part of the Figure at the time when the second invocation of f3 has taken place. The mutual recursion in this model can be broken in the function f4, which need not call f3. Since a function member is instantiated only at the time of the transition to it, not at compile time, no infinite recursion occurs in this example.

It will be appreciated that this allows proper modelling of immediately recursive calls, indirectly recursive calls, deep nesting, and calls from several clients.

The above described technique in effect uses infinite state machines, rather than the conventional finite state machines, since it is theoretically capable of containing arbitrarily many states.

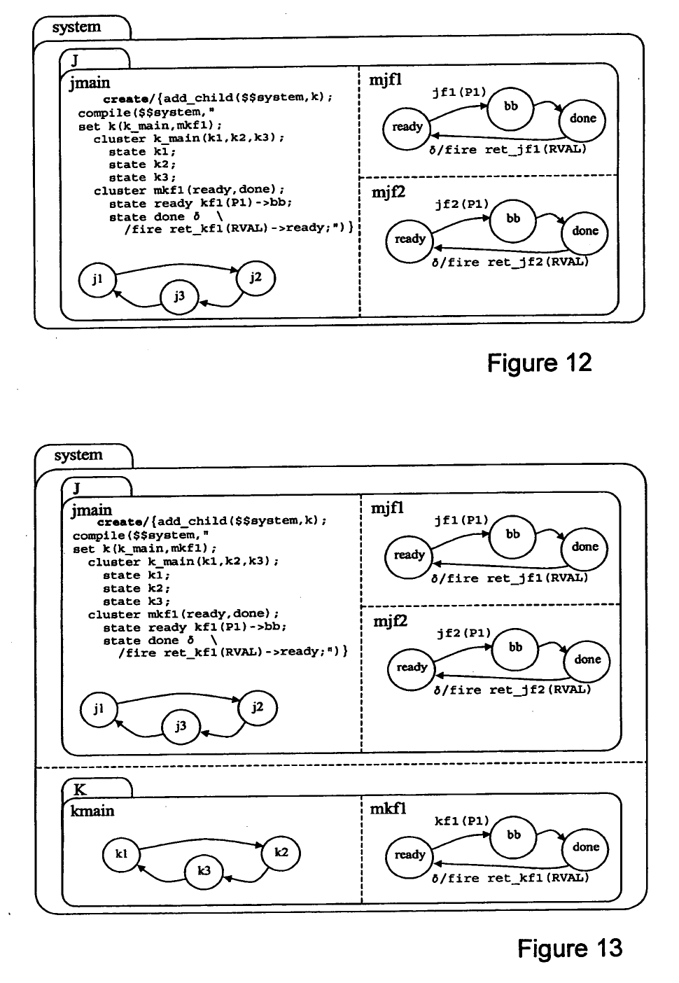

To model the action on the configurator of FIG. 5, including its creation of the two components, it is possible to allow the state machine model to modify itself to represent the new state structure on creation of the components. This is illustrated in FIGS. 12 and 13. In FIG. 12, a transition from a leafstate j1 to another leafstate j2 in a cluster jmain causes code to be run, which code causes the creation of set k. The state machine model resulting from the code running event triggered by the transition is shown in FIG. 13. As an optimisation, the dynamic ‘compile’ action could incorporate pre-compiled program code.

In summary, a state machine model according to the invention allows for recursive set members. These have the property of always responding to a particular starting event, cloning a new statechart member every time a call is made. Recursive set members could be denoted by the symbol

[symbol]

If there are several instances of a called function, the state machine execution logic is required to direct certain events to the right recipient or recipients. Calls from separate clients behave similarly to calls on separate threads, each with its own stack. Calls to ‘from function to function’ and their ‘returns’ are like stack push-and-pop operations on the same thread. Return events are required to be directed to the deepest caller on any particular thread. This is very probably directly analogous to what is happening in the system which is being modelled. Global events are required to be recognized as such since they are distinct from return events and do not entail any analogy to a push or pop operation. Global events can trigger transitions indiscriminately.

The concept of recursive set members can be applied to synchronous and to asynchronous situations. Synchronous function calls are considered here first.

In a synchronous function call, the function call executes on the caller's thread. When the function call returns, it is regarded as complete. Clearly, the caller cannot make a second function call until a synchronous call completes, since the thread of control is not available. Within the category of synchronous function calls, it is possible to distinguish between bound calls and unbound calls.

A bound function call runs to completion without requiring any more events to drive it to completion. Such a call is typically CPU-bound—an example is a function to find the longest or maximum of a list of numbers. Alternatively, the bound function call might involve an activity which frees up the CPU (e.g. by performing some I/O (input/output)), but the execution is regarded in the model as predetermined rather than dependent on the presence of an event. If the function call is not modelled as an atomic occurrence, i.e. if there can be an intervening event between start and completion, then the function call is better modelled as an unbound function call.

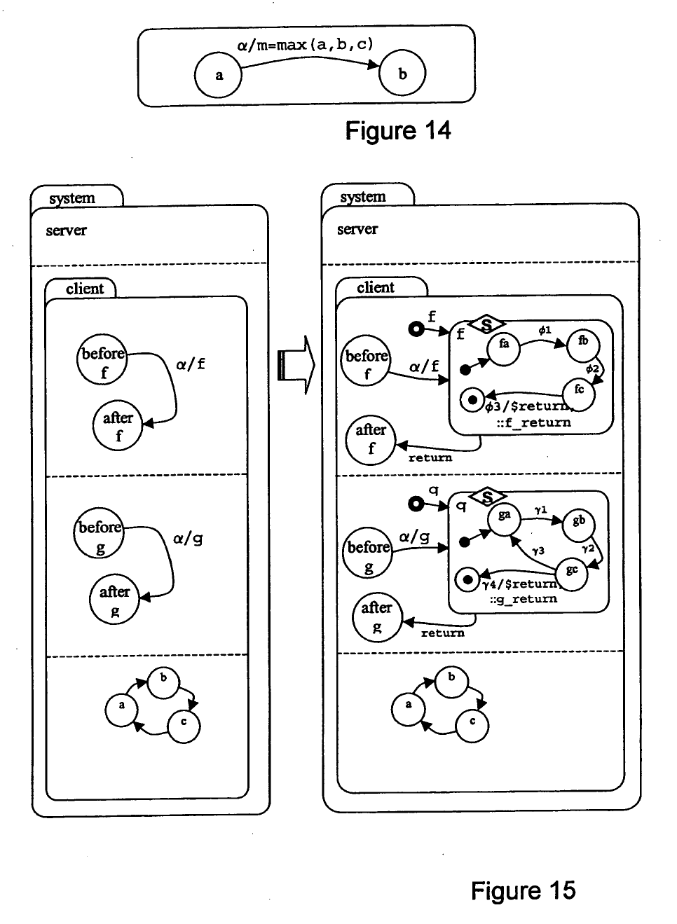

A bound function call may be modelled as a simple library function in an assignment action on a transition as shown in FIG. 14. Here, event a causes a transition to leafstate b although the transition can only be completed after the setting of a variable m to equal the maximum value of variables a, b and c.

A bound function call is capable of firing other events. A standard library module can easily provide for this.

An unbound function call requires the occurrence of at least one additional event to drive the function to completion. For example, if a function obtains input from a user, it might be modelled as requiring the event “input_obtained” to complete it. Here, the case of restricting the user to one function call per transition is considered initially. Single implantations are made per set member on the call. FIG. 15 illustrates the process. In FIG. 15 and the following figures, fire events on transitions are abbreviated to ‘f’, ‘g’, ‘$return’ and so on, i.e. the word ‘fire’ is omitted.

In FIG. 15, the optional fired events on the right hand side marked “::f_return” and “::g_return” are optional additions. They are included for completeness because they would be useful in the event of a queued call. The notation “::” indicates global scope. These optional events provide a notification whenever and wherever the de-queued function call (and Implantation) are handled in the state chart. The state charts at the bottom of each side of the Figure denote responses to other events generated by the function calls.

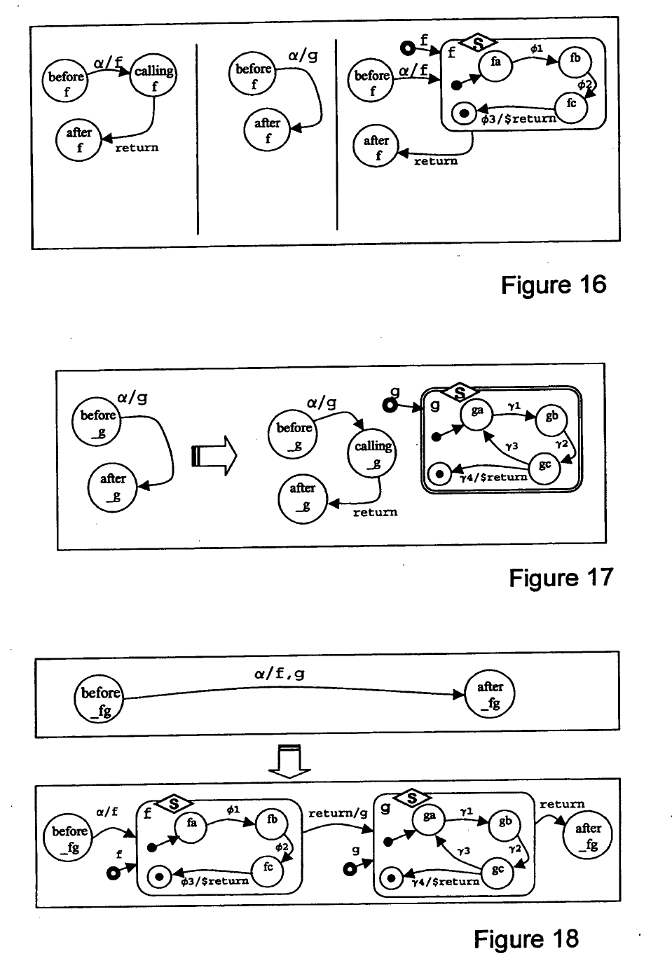

Two options are possible for representing the client side call—one with an intermediate “calling” state (shown in the left section of FIG. 16) and one without (shown in the middle section of FIG. 16) but both corresponding to the same implementation in principle (shown in the right portion of FIG. 16). The representation of FIG. 15 is expected to be more developer friendly.

The arrow [symbol] in FIG. 15 indicates the dynamic transformation of the state machine when the event α occurs. A new state machine element is implanted on the calling event—indicated by [symbol] . It is not necessarily adequate to perform a static implantation of the function (e.g. at compile time) as some functions are recursive; it is only at run-time that the termination condition can be identified and executed. It will be noted that the tip of the transition is to the newly created element not the state indicated by the user, which is reached only on function completion. The clusters marked <S> are implanted on function call, and are removed on completion. The standard notation [symbol] shows what state is entered on creation of the implantation. Function calls do not remember state history from one invocation to another. The notation ⊚ (called a terminator) indicates that the implantation is to be removed after a transition entering the terminator. There could be several different transitions to the terminator. There can be more than one initial state in implantable machine models, possibly based on the values of the parameters passed with the event. If necessary, fork nondeterminism could be applied on the next transition. Although the implantations shown in the example are clusters, they could be sets, or even leafstates.

Whatever the option chosen for the user representation in the state machine model, the implementation may make use of the technique used by asynchronous calls. This is shown in FIG. 17. In FIG. 17, the user cannot make use of any apparent asynchronous functionality, because the state marked ‘calling_g’ is not accessible for any other transitions. The client is locked in the state ‘calling_g’ until the return event is fired within function call g.

If several synchronous calls are put on a transition, they are interpreted in the model as a sequence. The implementation translates this into a chain of transitions, either built up in one go or created step-by-step. The principle is illustrated in FIG. 18, in which an event α fires functions f and g. The function calls f and g are instantiated in a chain between the originator state before _fg and the target state after _fg.

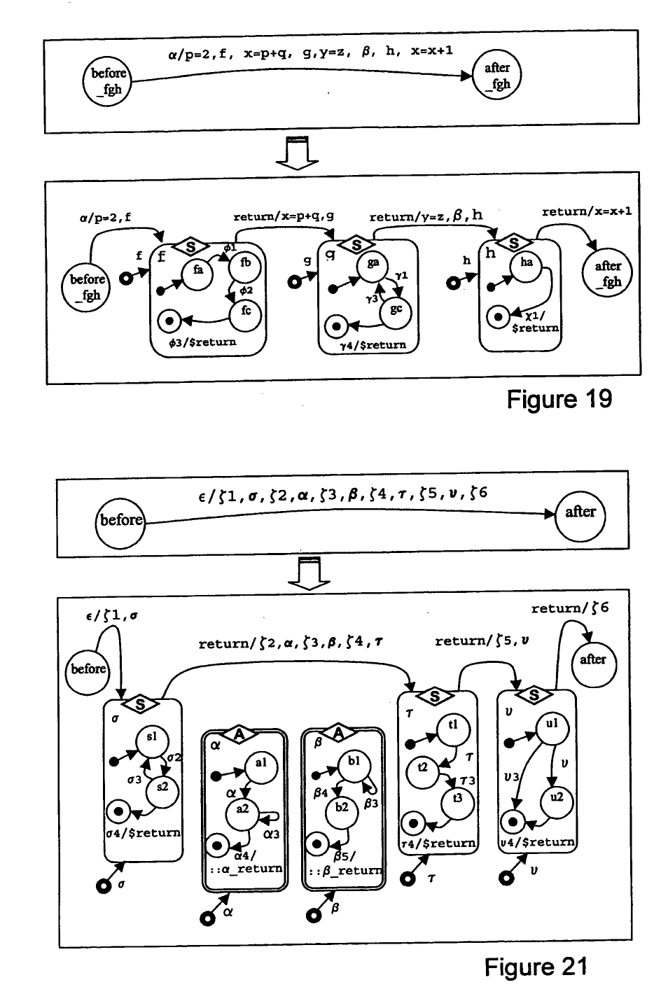

If a sequence of actions contains a mixture of function calls and other actions, for example:
α/f, x=p+q, g,y=z, β, h, x=x+1
   where f, g, and h are function call events, but β is just a global event, then chaining puts the non-function-call actions on the linking transitions. This is shown in FIG. 19. The sequence (micro-step) in which the non-function-call actions, including the initial one, take place, is dependent on the transition algorithm. Possible implementation techniques are to make all implantations in the chain in one go, or to make them at the latest possible time, i.e. just before they are needed.

An asynchronous function call, on the other hand, provides return of control to the caller, here termed a pending return, but the function continues to do some (or all) processing on another thread. When the processing associated with the function call is complete, the function call provides a notification. It is possible that intermediate and final notifications could be given, indicating the completion of certain phases of processing, but any final notification means that no more notifications can come from this function invocation. The intermediate notifications can be regarded as ordinary broadcast events. In this connection, broadcast events are the same as fired events.

An asynchronous function call may, depending on run-time circumstances, provide either a synchronous-like completion, or a pending ‘return’ with ‘notification’ later. A request for a web page is used here as an example. If the page is in cache, it may be returned quickly with completion. Otherwise, the function call returns ‘pending’, accesses the page over the Internet (for example), and ‘notifies’ when the page has been obtained.

With the model according to the invention, it is possible to have several asynchronous function calls outstanding at any one time, each function call running on a respective thread. For this reason, in a state machine model, the caller and all called functions are able to transition independently. Also, by parameterising the events, or by using names related to the function name, provided is a means to distinguish pending, notify and other events. This avoids ambiguity as to which function produced it.

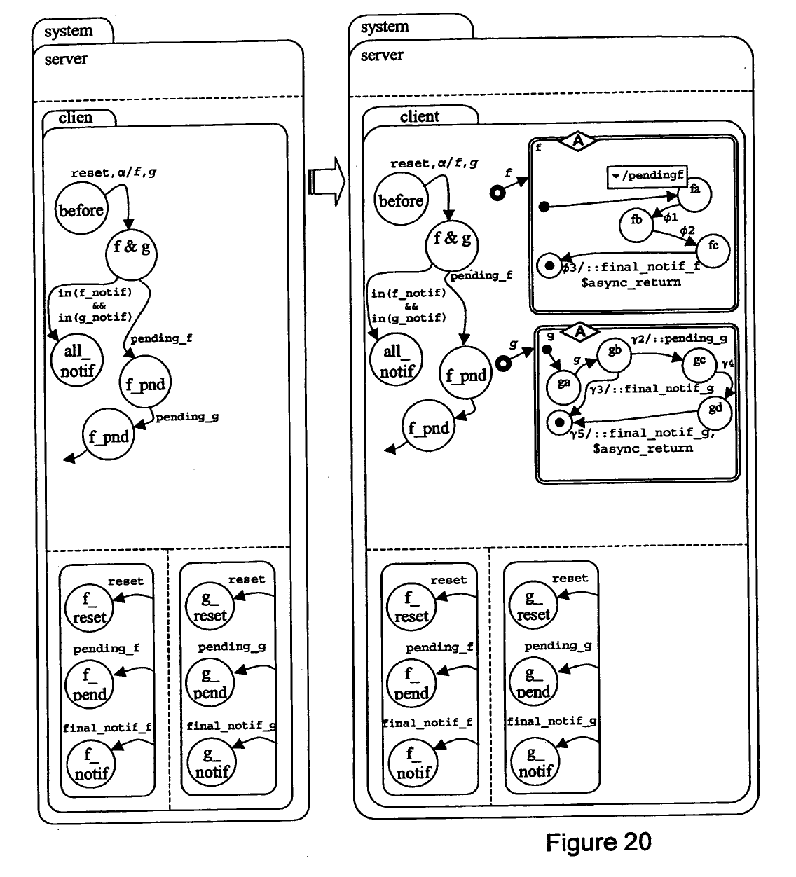

When an event representing an asynchronous function call is processed, a state-machine element is implanted, but with a special status indicated here by a double perimetral line. The special status ensures that the implantation has a scope that is effectively local to the caller, and a lifetime that is independent of that of caller. For multiple function calls, a temporary implantation of a machine element is performed for every function called. An implementation of asynchronous function calls is illustrated in FIG. 20. In this figure, a transition from leafstate ‘before’ to leafstate ‘f&g’ fires asynchronous function calls ‘f’ and ‘g’, which results in the state machine model shown on the right hand side of the figure. Here, function calls ‘f’ and ‘g’ are implanted or instantiated in free space but within the set named ‘client’. In the function call ‘f’, an event ‘pending_f’ is fired as a leafstate ‘fa’ is entered, which causes a transition from leafstate ‘f&g’ to leafstate ‘f_pnd’. In function call ‘g’, an event ‘::pending_g’ is fired only on transition from leafstate ‘gb’ to leafstate ‘gc’ This causes transition from leafstate ‘f_pnd’ to ‘g_pnd’. An event ‘::final_notif_g’ is fired on entering the terminator from either of leafstates ‘gb’ and ‘gd’. In this Figure, behaviour is modelled via two routes: if f fires ‘pending’ before g then transition is made to state f_pend; if g fires pending before f does so, no transition is made either until both functions notify or until f fires ‘pending’.

FIG. 20 shows that a client can respond to pending notifications and/or completion notifications. For clarity, the Figure does not show every combination of notifications from f to g. The state “f&g” cannot be omitted. The specific and generic handling should be noted.

With asynchronous function call modelling, notification events are global (indicated by the “::” operator), which ensures that all recipients see them. The names of the notification events are required by the model to be unique. The fired events on the right hand side of FIG. 20, marked “$async_return” are optional. They are included for completeness because they are needed in the event of a pumped call.

Each of the implanted machine elements, marked <A>, has the scope of being a sibling of the element at the tip of the transition arrow. They are scoped as though they are cluster members. Occupancy overrides cluster rules. The scope is not related to the effective source leafstate, nor any orbital state. (Orbital states are states above the common ancestor of source and target states, where a transition specifies that states must be exited and re-entered up to this orbital state). This fixed policy facilitates precise targeting of broadcast events and variables when scoping operators are used.

The implanted machine elements, marked <A> and having a double perimetral line, can be regarded as extra active members of their parent. Thus, in the case of the parent being a cluster, the implanted machine elements break the ordinary rule that only one active member is allowed in a cluster. However, the implantation can be thought of as independent of its machine-path parent, since it has an independent life-cycle. The parent may not have the implantation marked as a child, so the implantation will not take part in algorithms which examine a parent's children. In this way, a cluster can be exited, for example, without interfering with the life-cycle of the implanted member.

The lifecycle of an implanted asynchronous function is independent of the lifetime of any other machine. It is destroyed only when the transition to the terminator (symbol⊚) takes place. Even if a parent is another function and is destroyed, the asynchronous function remains alive until it transitions to its own terminator.

Additional intermediate notifications can be included as well as a final notification. Only the final notification corresponds to the function implantation being removed; the modelling system knows that the implantation is to be removed from the fact that the transition is a transition to a terminator. From an implementation perspective, even a final notification behaves like any other broadcast event.

As mentioned above, events such as “pending” and “notify” need to identify the function they apply to by their name. Accordingly, events are parameterised, which disambiguates between broadcast events from each of a function called twice (or more) in the same scope. (There are various ways in which some function can be called twice in the same scope).

More deeply nested parts of the implanted machine, if present, can use a $$ scoping operator, for example, when targeting fired events at the caller.

If a transition contains calls to synchronous and asynchronous functions, implantations of the relevant kind can be provided systematically. In the example of FIG. 21, events σ, T, U are synchronous functions, events α β are asynchronous functions, and other events (ε ζ1-ζ6 and return events) are ordinary global events. Here, on transitioning from leafstate ‘before’ to leafstate ‘after’, a chain of synchronous function calls are implanted between the two leafstates, and two asynchronous function calls are implanted in free-space. It will be seen that the function calls and events fired by the transition are handled by the model in the order in which they are listed. The transition between any two sequential synchronous function calls fires the events that are listed between the calling of the functions on the pre-implantation model. The reaching of the leafstate ‘after’ is not dependent on either of the asynchronous function calls reaching their terminator and thus completing.

Here, the synchronous function calls may be implemented using the asynchronous function call modelling technique.

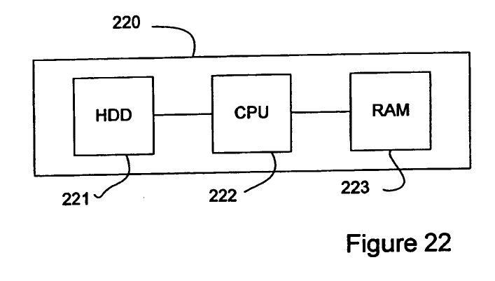

The invention may be carried out using any suitable computer, such as the personal computer of FIG. 22. The computer 220 comprises a control processing unit 221, which runs a state machine modelling program stored on a hard disk drive 222. During the running of the program, a model of the state machine is built and stored in RAM 223.

1. A method of modelling a state machine comprising a first state model (client1), and a second state model (mf1) implementing a function call, the method comprising, in response to an event in the first state model instructing the firing of the function call, implanting the second state model in the first state model.

2. A method according to claim 1, in which the second state model is absent of history information.

3. A method according to claim 1, in which the second state model contains one or more clusters (client1, client2).

4. A method according to claim 1, in which the second state model contains one or more sets (system).

5. A method as claimed in claim 1, in which the second state model contains two or more leafstates (f1_a, f1_b) having one or more event driven transitions (β) therebetween.

6. A method as claimed in claim 5, in which one or more of the transitions fires a notification event (pending_f, final_notif_g).

7. A method as claimed in claim 1, in which the second state model is implanted over an explicit marker state (calling) of the first state model.

8. A method as claimed in claim 1, in which the second state model is implanted over an implicit marker state of the first state model.

9. A method as claimed in claim 7, in which the second state model is deleted on completion.

10. A method as claimed in claim 9, in which the model allows the entering of a state in the first model local to the caller of the second state model only on deletion of the second state model.

11. A method as claimed in claim 7, in which local declarations and/or scoping operators are used in the second state model.

12. A method as claimed in claim 11, in which a return event from the second state model uses a “back” scoping operator ($).

13. A method as claimed in claim 1, in which the second state model is implanted in free-space.

14. A method as claimed in claim 13, in which the lifetime of the second state model is independent of any other model.

15. A method as claimed in claim 13, in which the second state model is implanted local to the caller of the second state model.

16. A method as claimed in claim 13, in which notification events from the second state model are global.

17. A method as claimed in claim 13, in which the second state model is deleted on transition to a terminator forming part thereof.

18. A method as claimed in claim 1, in which events occurring in the second state model are parameterised.

19. A method as claimed in claim 1, in which events occurring in the first state model are parameterised.

20. A computer program containing instructions for a computer to carry out the method of claim 1.

21. A computer program as claimed in claim 19, further comprising instructions for a computer to generate an executable program exhibiting the same behaviour as the state model.

22. A computer program as claimed in claim 19, further comprising instructions for a computer to generate tests with an oracle, for testing an implementation conformant to the behaviour of the state model.

23. A computer programmed with the computer program of claim 19.

24. Apparatus for modelling a state machine comprising a first state model (client1) and a second state model (mf1) implementing a function call, the apparatus comprising means responsive to an event in the first state model instructing the firing of the function call, for implanting the second state model in the first state model.

25. Apparatus according to claim 24, in which the second state model contains one or more clusters (client1, client2).

26. Apparatus according to claim 24, in which the second state model contains one or more sets (system).

27. Apparatus according to claim 24, in which the second state model contains two or more leafstates (f1_a, f1_b) having one or more event driven transitions (β) therebetween.

28. Apparatus as claimed in claim 24, in which one or more of the transitions fires a notification event (pending_f, final_notif_g).

29. Apparatus as claimed in claim 24, in which the second state model is implanted over an explicit marker state (calling) of the first state model.

30. Apparatus as claimed in claim 24, in which the second state model is implanted over an implicit marker state of the first state model.

31. Apparatus as claimed in claim 29, comprising means for deleting the second state model on completion.

32. Apparatus as claimed in claim 31, in which the model allows the entering of a state in the first model local to the caller of the second state model only on deletion of the second state model.

33. Apparatus as claimed in claim 24, in which the second state model is implanted in free-space.

34. Apparatus as claimed in claim 33, in which the second state model is implanted local to the caller of the second state model.

35. Apparatus as claimed in claim 33, comprising means for deleting the second state model on transition to a terminator forming part thereof.
